(19) United States
(12) Patent Application Publication
(10) Pub. No.: US 2012/0097348 A1
(43) Pub. Date: Apr. 26, 2012

(54) DEVICE FOR OPENING AND CLOSING CURTAIN

(75) Inventors: Makoto Kanehira, Osaka (JP); Toshimitsu Sakai, Osaka (JP)

(73) Assignee: TSUBAKIMOTO CHAIN CO., Osaka (JP)

(21) Appl. No.: 13/321,123

(22) PCT Filed: Apr. 5, 2010
(86) PCT No.: PCT/JP2010/056174

§ 371 Date: Dec. 5, 2011

(30) Foreign Application Priority Data
May 21, 2009 (JP) 2009-122793

(51) Int. Cl. B60J 3/00; A47H 5/02

(52) U.S. Cl. 160/370.21

(57) ABSTRACT

There is provided a curtain opening/closing device whose number of parts is reduced, which is lightened, whose safety and durability are improved, whose installation space is reduced, whose appearance is improved and which can be installed freely along a curved surface, and a vehicle carrying the curtain opening/closing device. The curtain opening/closing device comprises a spiral long coil member, a movable member capable of moving within the long coil member, a rail member rotably and loosely fitting the long coil member and having a slit continuous in a longitudinal direction and a rotational driving section fixed at one end of the rail member and rotating and driving the long coil member. The movable member is inserted within the long coil member so as to be movable in the longitudinal direction.

### TECHNICAL FIELD

The present invention relates to a curtain opening/closing device having a curtain opening/closing mechanism that opens/closes a curtain by reciprocatively moving movable members connected with the curtain and reciprocatively guided and more specifically to a curtain opening/closing device suitable for opening/closing a sunshade installed over a window of a vehicle such as a motor vehicle.

### BACKGROUND ART

Hitherto, there is known a curtain opening/closing device having movable members connected with opening moving ends of a curtain and others and guided so as to reciprocate and a reciprocative driving means for guiding and driving the movable members in order to open/close the curtain and others provided over a window of a vehicle such as a motor vehicle by power of a motor and the like.

For example, a known curtain opening/closing device 500 is structured so as to open/close a curtain 501 which is provided over a window W of a vehicle and others and is wound by a curtain winding roller 503 as shown in FIG. 8 by moving up and down an opening moving end 502 provided at an end of the curtain 501.

One ends of upper links 505 are turnably connected to vicinities of both ends of the opening moving end 502, respectively, and other ends of the upper links 505 are turnably connected with one ends of lower links 506, respectively. The curtain 501 is opened/closed by turning other ends of the lower links 506 and by moving up and down the opening moving end 502 (see Patent Document 1 for example).

Another known curtain opening/closing device 600 is structured so as to open and close a curtain 601 provided over a window W of a vehicle and others and wound by a curtain winding roller 603 as shown in FIG. 9 by moving an opening moving end 602 provided at an end of the curtain 601.

Both ends of the opening moving end 602 are connected to movable members (not shown) that move within a pair of rail members 610 provided over the window W of the vehicle and others. The curtain 601 is opened/closed by moving the opening moving ends 602 up and down by moving the movable members within the rail members 610 (see Patent Document 2 for example).

### PRIOR ART DOCUMENT

Patent Document 1: Japanese Patent Application Laid-open No. 11-81822 (Pages 4 through 7, FIGS. 1 through 7)
Patent Document 2: Japanese Patent Application Laid-open No. 2001-241277 (Page 7, FIG. 5)

### DISCLOSURE OF INVENTION

### Problems to be Solved by the Invention

However, the former known curtain opening/closing device 500 has problems that it may possibly contact directly with people or things because the upper and lower links 505 and 506 are exposed, its safety and durability are low because driving mechanisms (not shown) for turning the lower links 506 must be provided at both ends, its installation space is large and it spoils an appearance.

The curtain opening/closing device 500 also has a problem that the opening moving end 502 can only move up and down straightly by the turn of the upper and lower links 505 and 506 and when it is applied to a window having a curved surface, it is unable to move the opening moving end 502 along the curved surface of the window.

The latter known curtain opening/closing device 600 is structured so as to move the movable members by reciprocating wire members provided within rail members 610 by a driving section 620 and so that the opening moving end 602 can be moved along the curved surface of the window W by providing the rail members 610 along the curved surface even when it is applied to the window having the curved surface. Because the rail members 610 can be bent and extended to the window W and the driving section can be stored in a space under the window W, the problems of safety and appearance, otherwise caused by the exposure, can be reduced.

However, the curtain opening/closing device 600 still has a problem that its installation space increases because the driving section 620 requires a size for storing the mechanism for reciprocating the wire members, a motor 621, i.e., a driving source, projects to the outside and it is necessary to provide drawing and storing sections 622 for storing the wire members drawn to sides opposite from the rail members 610 with respect to the driving section 620. Still more, sliding resistance of the wire members reciprocating within the rail members 610 is large, so that there is a problem in terms of durability of the wire members.

Accordingly, the present invention aims at solving the problems of the prior art curtain opening/closing devices described above by providing a curtain opening/closing device whose number of parts is reduced, which is lightened, whose safety and durability are improved, whose installation space is reduced, whose appearance is improved and which can be installed freely along a curved surface, and a vehicle carrying the curtain opening/closing device.

### Means for Solving the Problems

In order to solve the aforementioned problems, according to a first aspect of the invention, there is provided a curtain opening/closing device comprising a curtain opening/closing mechanism having movable members connected with a curtain and guided reciprocatively and a reciprocative driving means for guiding and driving the movable members,

wherein the reciprocative driving means has a spiral long coil member, a rail member rotably and loosely fitting the long coil member and having a slit continuous in a longitudinal direction and a rotational driving section that is fixed with one end of the rail member and rotates and drives the long coil member, and

each movable member has a movable body inserted within the long coil member movably in the longitudinal direction and a connecting member that is fixed to a side of the movable body and penetrates between a gap of spirals of the long coil member and through the slit of the rail member to be connected with the curtain.

According to a second aspect of the invention, the movable body has a cylindrical shape having a length of two pitches or more of the spirals of the long coil member and conical tapered portions at both ends in the longitudinal direction.

According to a third aspect of the invention, the rail members are provided on both sides in a width direction of the curtain and the rail members on the both sides are extended and bent rearward or frontward in a direction in which the curtain is opened/closed and are fixed to one rotational driving section.

According to a fourth aspect of the invention, the rotational driving section is a motor with a decelerator and is controlled by remote control.

According to a fifth aspect of the invention, the curtain is a sunshade provided over a window of a vehicle and the rail member is attached to a window frame of the vehicle.

According to a fifth aspect of the invention, a vehicle having a window and an openable curtain provided over the window is installed with the curtain opening/closing device described in any one of the first through fifth aspect of the invention as an opening/closing device of the curtain.

### Advantages

According to the curtain opening/closing device of the first aspect of the invention, because the curtain opening/closing device comprises the curtain opening/closing mechanism having the movable member connected with the curtain and guided reciprocatively and the reciprocative driving means for guiding and driving the movable member;

the reciprocative driving means has the spiral long coil member, the rail member rotably and loosely fitting the long coil member and having the slit continuous in the longitudinal direction and the rotational driving section that is fixed with one end of the rail member and rotates and drives the long coil member;

each movable member has the movable body inserted within the long coil member movably in the longitudinal direction and the connecting member that is fixed to the side of the movable body and penetrates between the gap of spirals of the long coil member and through the slit of the rail member to be connected with the curtain, it becomes possible to reduce sliding resistance, to downsize the rotational driving section, to improve safety and durability and to reduce an installation space because only the long coil member rotates within the rail member and only the movable member reciprocates within the long coil member.

Still more, because the rail member and the long coil member can be made flexible, it becomes possible to install the curtain opening/closing device freely along the curved surface and to improve the appearance.

According to the curtain opening/closing device of the second aspect of the invention, because the movable body has the cylindrical shape having the length of two pitches or more of the spirals of the long coil member and the conical tapered portions at the both ends in the longitudinal direction, the sliding resistance of the movable members in reciprocating within the long coil member is reduced even if the rail member and the long coil member are curved. Still more, it becomes possible to downsize the rotational driving section, to improve the safety and durability of the curtain opening/closing device and to reduce the installation space.

According to the curtain opening/closing device of the third aspect of the invention, because the rail members are provided on the both sides in the width direction of the curtain and the rail members on the both sides are extended and bent rearward or frontward in the direction in which the curtain is opened/closed and are fixed to one rotational driving section, it becomes possible to reduce the installation space further.

According to the curtain opening/closing device of the fourth aspect of the invention, because the rotational driving section is the motor with the decelerator and is controlled by remote control, it becomes possible to reduce the installation space further.

According to the curtain opening/closing device of the fifth aspect of the invention, because the curtain is the sunshade provided over the window of the vehicle and the rail member is attached to the window frame of the vehicle, it becomes possible to reduce a number of parts and to lighten a weight of the vehicle such as a motor vehicle. It becomes also possible to improve the safety and durability of the curtain opening/closing device, to reduce the installation space further and to improve the appearance by providing the curtain opening/closing device freely along the curved surface.

According to a fifth aspect of the invention, because the vehicle having the window and the openable curtain provided over the window is provided with the curtain opening/closing device described in any one of first through fifth aspects of the invention as the opening/closing device of the curtain, it becomes possible to reduce the number of parts and to lighten the weight of the vehicle. It becomes also possible to improve the safety and durability of the curtain opening/closing device, to reduce the installation space further and to improve the appearance by providing the curtain opening/closing device freely along the curved surface.

### BRIEF DESCRIPTION OF DRAWINGS

FIG. 1 illustrates an installation of a curtain opening/closing device according to an embodiment of the invention.

FIG. 2 is a perspective view of the curtain opening/closing device of the embodiment of the invention.

FIG. 3 is a side view of a part of FIG. 2.

FIG. 4 is a perspective view of a long coil member and a movable member in FIG. 2.

FIG. 5 is a section view taken along a line A-A in FIG. 2.

FIG. 6 is a partially cutaway side view near rotational driving section in FIG. 2.

FIG. 7 is a perspective view of the long coil member and a driving shaft in FIG. 2,

FIG. 8 is a perspective view of a prior art curtain opening/closing device.

FIG. 9 illustrates an installation of another prior art curtain opening/closing device.

### BEST MODE FOR CARRYING OUT THE INVENTION

A specific mode of the invention may be any mode as long as a curtain opening/closing device comprises a curtain opening/closing mechanism having movable members connected with a curtain and guided reciprocatively and a reciprocative driving means for guiding and driving the movable members; wherein the reciprocative driving means has a spiral long coil member, a rail member rotably and loosely fitting the long coil member and having a slit continuous in a longitudinal direction and a rotational driving section that is fixed with one end of the rail member and rotates and drives the long coil member; and each movable member has a movable body inserted within the long coil member movably in the longitudinal direction and a connecting member that is fixed to a side of the movable body and penetrates between a gap of spirals of the long coil member and through the slit of the rail member to be connected with the curtain. Then, the curtain opening/closing device permits to reduce a number of parts, to lighten a weight of a vehicle, to improve safety and durability of the curtain opening/closing device, to reduce an installation space and to improve an appearance by being provided freely along a curved surface.

That is, the rail member used in the invention may be composed of any material and is preferably composed of a self-lubricant flexible resin or the like whose sliding resistance with the long coil member that rotates within the rail member is small.

The long coil member used in the invention may be also composed of any material and may be selected appropriately by considering rigidity required for moving the movable member and elasticity required to bend together with the rail member. Still more, the surface of the rail member may be coated with a lubricant material to reduce the sliding resistance with the rail member and the movable member.

The movable member used in the invention may be composed of any material and is preferably composed of a light-weight self-lubricant resin or the like whose sliding resistance with the long coil member is small.

Still more, the curtain opened and closed in the invention includes all kinds of curtains, blinds, shades, screens and other which are used for the purpose of blocking off sun-light and visual lines.

### Embodiment

A curtain opening/closing device of one embodiment of the invention will be explained below with reference to the drawings.

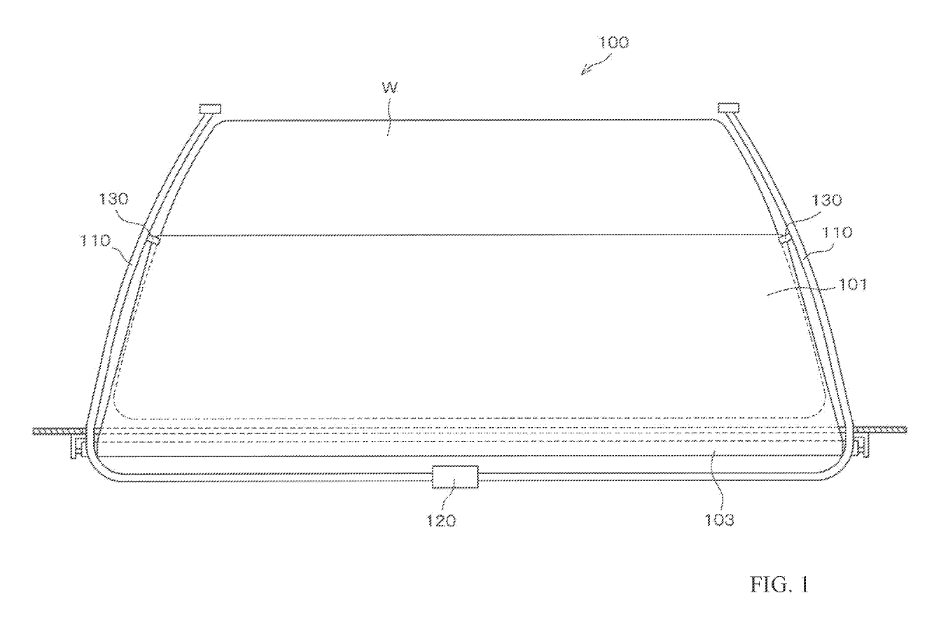

As shown in FIG. 1, a curtain opening/closing device 100 of the embodiment of the invention is structured so as to open/close a curtain 101 provided over a window W of a vehicle and others by moving widthwise both ends of the curtain 101 wound by a curtain winding roller 103 up and down.

The widthwise both ends of the curtain 101 are connected with movable members moving within a pair of rail members 110 provided over the window W of the vehicle and others. Then, the curtain 101 is opened/closed by moving the movable members within the rail members 110 so that the widthwise both ends of the curtain 101 move up and down.

The curtain 101 is formed to be stretchable in the width direction and is structured so that it is wound by a curtain winding roller 103 with a maximum width of the window W of the vehicle and others and so that its width stretches corresponding to a width of the pair of rail members 110. Accordingly, it is possible to always cover the whole window W of the vehicle and others in the width direction to position to which the curtain 101 is drawn.

The pair of rail members 110 is provided on window frames on both sides in the width direction of the curtain 101 and is extended and bent under the curtain winding roller 103 to be fixed to one rotation driving section 120.

It is noted that drawing ends of the curtain 101 may be formed to be stretchable corresponding to the width of the pair of rail members 110 as an opening moving end provided separately like the prior art example.

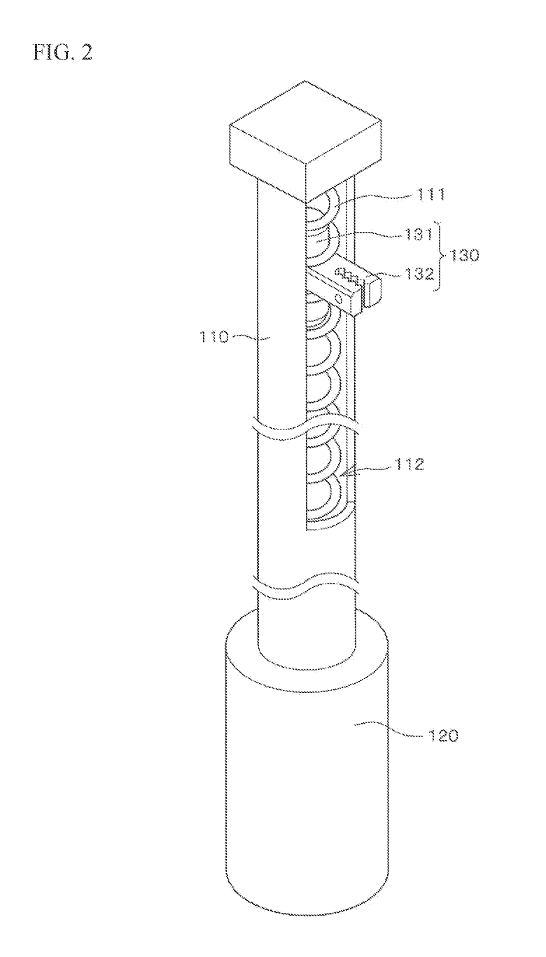

As shown in FIG. 2, the curtain opening/closing device 100 includes the movable member 130 capable of moving within a spiral long coil member 111, the rail member 110 rotably and loosely fitting the long coil member 111 and having a slit 112 continuing in a longitudinal direction and a rotational driving section 120 fixed at one end of the rail member 110 and rotationally driving the long coil member 111.

Ends of the rail member 110 on the sides opposite from the rotational driving section 120 are opened to attach/remove the long coil member 111 and the movable member 130 during its assembly and maintenance and are closed by caps 113 during its use.

While the slit 112 may be provided at least within a range in which the movable member 130 reciprocates to open/close the curtain 101, the slit 112 may be provided across the whole length of the rail member 110 to lower its cost and to facilitate its assembly.

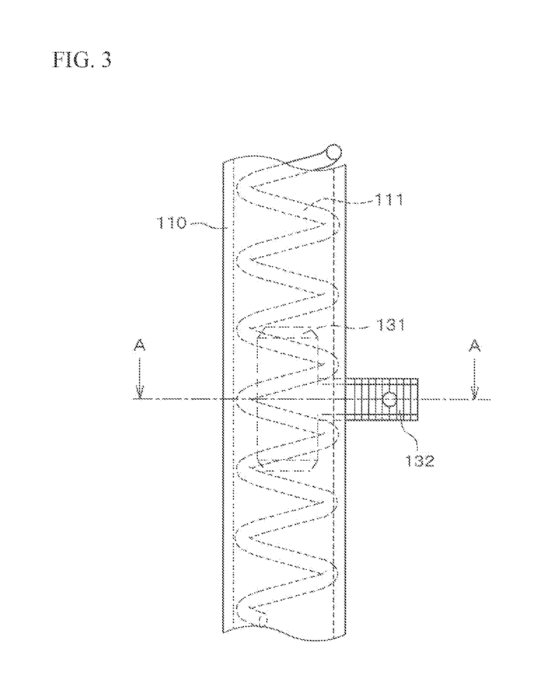

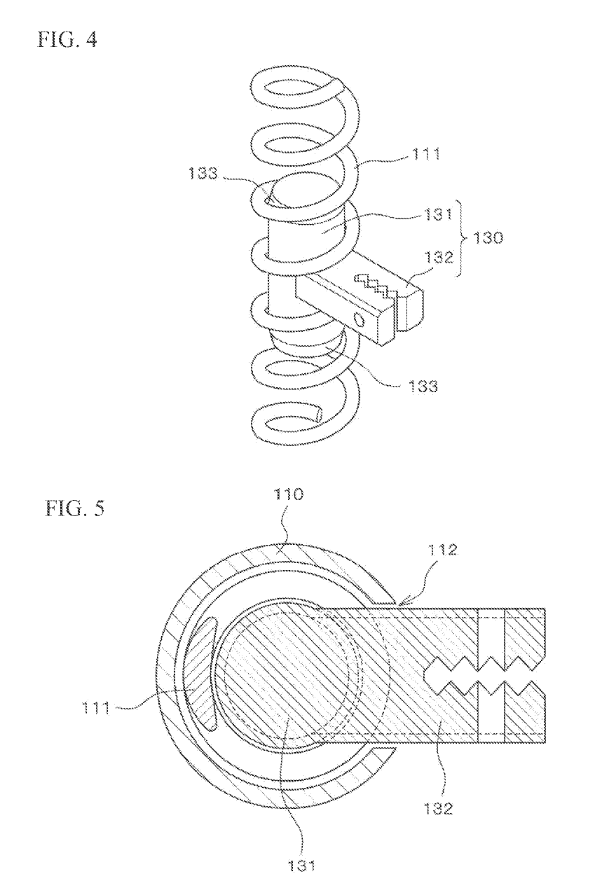

As shown in FIGS. 3 through 5, the movable member 130 comprises a movable body 131 movably inserted through the inside of the long coil member 111 in the longitudinal direction and a connecting member 132 that is fixed to a side of the movable body 131, penetrates through a gap of spirals of the long coil member 111 and the slit 112 of the rail member 110 and is connected with the opening moving end 102 of the curtain 101. The movable member 130 reciprocates within the long coil member 111 when the long coil member 111 rotates with respect to the rail member 110.

The movable body 131 has a cylindrical shape having a length of two pitches or more of the spiral of the long coil member 111 and has conical tapered portions 133 on its both ends in the longitudinal direction, so that it smoothly reciprocates within the long coil member 111 even if the rail member 110 and the long coil member 111 are curved.

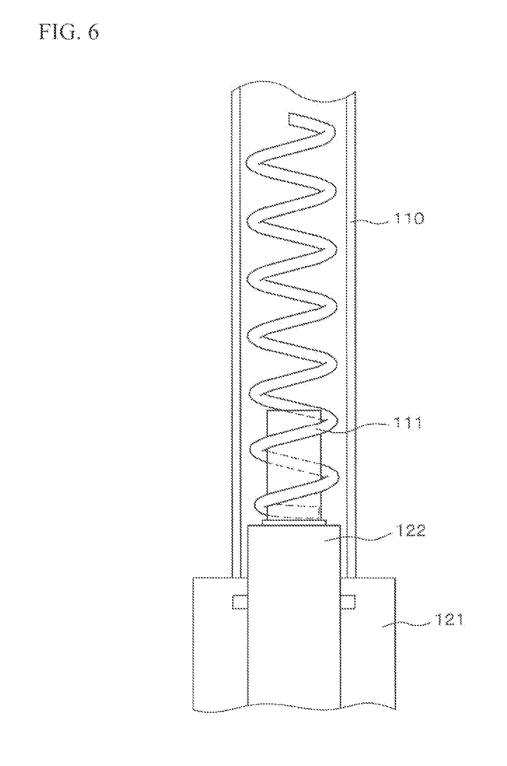

As shown in FIG. 6, the rotational driving section 120 comprises a motor 121 whose driving shaft 122 projects and one end of the rail member 110 is fixed so as to contain the driving shaft 122.

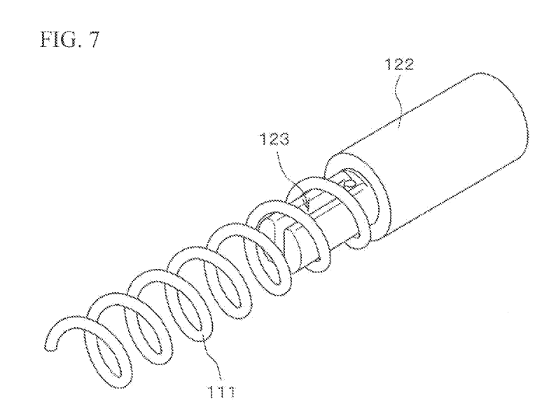

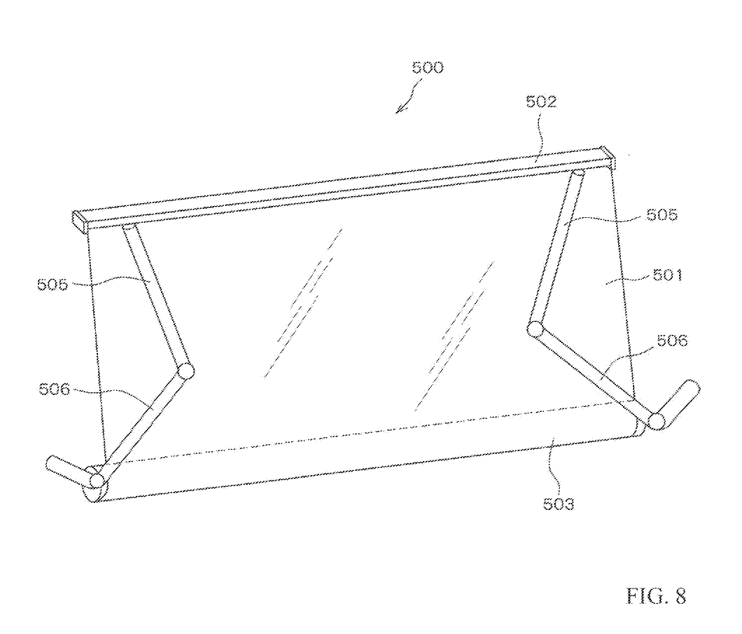

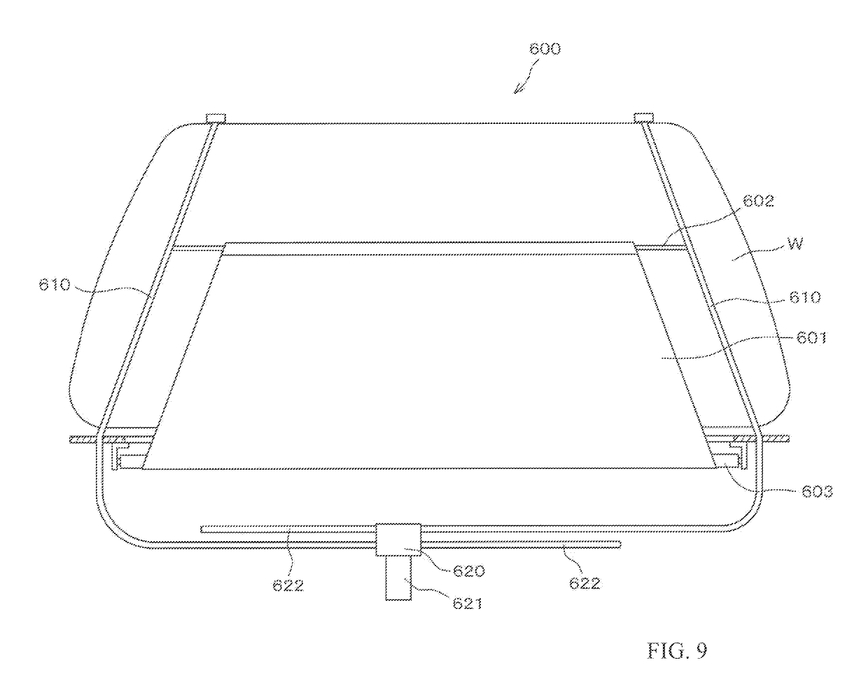

As shown in FIG. 7, the driving shaft 122 is provided with an end having a cut 123 in the axial direction to engage with an end of the long coil member 111 to rotate and drive the long coil member 111.

It is noted that the motor 121 may be a motor with a decelerator and the driving shaft 122 may be its output shaft. It is also possible to arrange so as to be able to control the rotation by remote control from a driver's seat when the device is installed in a vehicle such as a motor vehicle.

### INDUSTRIAL APPLICABILITY

As described above, the curtain opening/closing device 100 of the invention is capable of opening/closing the curtain 101 by rotating the long coil member 111 by rotating the driving shaft 122 and by moving the curtain 101 up and down by moving the movable member 130 within the long coil member 111 in the longitudinal direction.

Then, it becomes possible to reduce sliding resistance, to downsize the rotational driving section 120, to improve safety and durability and to reduce an installation space because only the long coil member 111 rotates within the rail member 110 and only the movable member 130 reciprocates within the long coil member 111. Still more, because the rail member 110 and the long coil member 111 can be made flexible, it becomes possible to install the curtain opening/closing device 100 freely along a curved surface and to improve an appearance.

It is noted that although the curtain opening/closing device 100 of the present embodiment has been applied as a sunshade provided over the window of the vehicle, the curtain opening/closing device 100 can be used for a window of a building and the like, for opening/closing hangings other than a curtain and for opening/closing hanged curtain and hangings in a horizontal direction by providing above them.

### REFERENCE NUMERALS

100, 500, 600 Curtain opening/closing device
101, 501, 601 Curtain
502, 602 Opening moving end
103, 503, 603 Curtain winding roller
505 Upper link
506 Lower link
110, 610 Rail member
111 Long coil member
112 Slit
113 Cap
120 Rotation driving section
620 Driving section
121, 621 Motor
122 Driving shaft
622 Drawing storing section
123 Cut
130 Movable member
131 Movable body
132 Connecting member
133 Tapered portion
W Window

1. A curtain opening/closing device comprising a curtain opening/closing mechanism having:
a movable member connected with a curtain and which is guided reciprocatively; and
a reciprocative driving means for guiding and driving the movable member, wherein said reciprocative driving means includes:
a spiral long coil member;
a rail member which encloses said long coil member such that the spiral long coil member is able to rotate therein, the rail member having a slit continuous in a longitudinal direction;
a rotational driving section that is fixed to one end of the rail member and that rotates and drives said long coil member;
a movable body inserted within an inside of said long coil member and said movable member, the movable body being movable in the longitudinal direction; and
a connecting member that is fixed to a side of the movable body and penetrates between a gap of spirals of the long coil member and through the slit of said rail member to be connected with the curtain.

2. The curtain opening/closing device according to claim 1, wherein said movable body has a cylindrical shape having a length of two pitches or more of the spirals of said long coil member and conical tapered portions at both ends in the longitudinal direction.

3. The curtain opening/closing device according to claim 1, wherein said rail members are provided on both sides in a width direction of said curtain; and
said rail members on the both sides are extended and bent rearward or frontward in a direction in which said curtain is opened/closed and are fixed to one rotational driving section.

4. The curtain opening/closing device according to claim 1, wherein said rotational driving section is a motor with a decelerator and is controlled by remote control.

5. The curtain opening/closing device according to claim 1, wherein said curtain is a sunshade provided over a window of a vehicle; and
said rail member is attached to a window frame of the vehicle.

6. A vehicle having a window and an openable curtain provided over the window, wherein the curtain opening/closing device described in claim 1 is installed as an opening/closing device of said curtain.
